(19) United States
(12) Patent Application Publication
(10) Pub. No.: US 2023/0260209 A1
(43) Pub. Date: Aug. 17, 2023

(54) TRAINING DATA GENERATION DEVICE AND TRAINING DATA GENERATION METHOD

(71) Applicant: Mitsubishi Electric Corporation, Tokyo (JP)

(72) Inventors: Yoshihiro TOMARU, Tokyo (JP); Toshihisa SUZUKI, Tokyo (JP)

(73) Assignee: Mitsubishi Electric Corporation, Tokyo (JP)

(21) Appl. No.: 18/137,669

(22) Filed: Apr. 21, 2023

Related U.S. Application Data
(63) Continuation of application No. PCT/JP2020/045514, filed on Dec. 7, 2020.

(51) Int. Cl. G06T 17/00; G06T 7/194; G06T 7/40; G06T 7/62; G06T 7/70; G06V 10/25

(52) U.S. Cl. CPC G06T 17/00; G06T 7/194; G06T 7/40; G06T 7/62; G06T 7/70; G06V 10/25; G06T 2207/10028

(57) ABSTRACT

A training data generation device includes: a 3D model acquiring unit to acquire a 3D model of an object; a partial image acquiring unit to acquire a partial image that is an image area in which the object appears in a photographed image; a texture coordinate acquiring unit to acquire two-dimensional texture coordinates for texture-mapping the partial image on the 3D model on the basis of the partial image and the 3D model; a rendering condition acquiring unit to acquire a rendering condition that is a condition for rendering a 3D model with texture obtained by texture-mapping the partial image on the 3D model on the basis of the two-dimensional texture coordinates; a two-dimensional image acquiring unit to acquire a two-dimensional image by rendering the 3D model with texture on the basis of the rendering condition; and a training data output unit to output the two-dimensional image.

### CROSS REFERENCE TO RELATED APPLICATION

This application is a Continuation of PCT International Application No. PCT/JP2020/045514, filed on Dec. 7, 2020, which is hereby expressly incorporated by reference into the present application.

### TECHNICAL FIELD

The present disclosure relates to a training data generation device and a training data generation method.

### BACKGROUND ART

A technique in which photographed image information indicating a photographed image that is obtained by photographing an object is input to a trained model as an explanatory variable, and the trained model is caused to infer a shape, a center position, a type, or the like of the object is used.

In order to cause the trained model to perform highly accurate inference, it is necessary to prepare a large amount of training data for training the learning model.

For example, Non-Patent Literature 1 discloses, in the field of robot control technology, a technology of generating a trained model by training a learning model, by using as training data, not photographed image information but only CG image information indicating a CG image obtained by photographing, with a virtual camera, a three-dimensional (Hereinafter referred to as “3D”.) model created by computer graphics (Hereinafter, referred to as “CG”.), and generating a trained model capable of inferring a center position of an object appearing in a photographed image indicated by the photographed image information by inputting the photographed image information as an explanatory variable.

In the technology disclosed in Non-Patent Literature 1 (Hereinafter, referred to as “the related art”.), it is possible to generate a large amount of training data by photographing a 3D model created by CG with a virtual camera.

### CITATION LIST

### Non-Patent Literature

Non-Patent Literature 1: “Josh Tobin, Rachel Fong, Alex Ray, Jonas Schneider, Wojciech Zaremba, Pieter Abbeel”, “Domain Randomization for Transferring Deep Neural Networks from Simulation to the Real World”, [online], “arXiv preprint arXiv:1703.06907”, [Searched on Nov. 12, 2020], Internet (URL: https://arxiv.org/abs/1703.06907)

### SUMMARY OF INVENTION

### Technical Problem

The 3D model in the related art is a 3D model created by CG, and is a 3D model having a simple shape and pattern. Therefore, the related art is suitable for generating a trained model for inferring the shape, center position, type, or the like of an object having a simple shape or pattern.

However, in the related art, in order to generate a trained model for accurately inferring the shape, center position, type, or the like of an object having a complicated shape or pattern, it is necessary to train the learning model using more training data. That is, the related art has a problem that it takes a long time for a learning model to train in order to generate a trained model for accurately inferring a shape, a center position, a type, or the like of an object having a complicated shape or pattern.

The present disclosure is intended to solve the above-described problem, and an object of the present disclosure is to provide a training data generation device that can generate training data capable of making a training time required to generate a trained model capable of accurately inferring a shape, a center position, a type, or the like of an object shorter than that in the related art even if the object has a complicated shape or pattern.

### Solution to Problem

A training data generation device according to the present disclosure includes processing circuitry to acquire partial image information indicating a partial image that is an image area in which an object appears in a photographed image, to acquire 3D model information indicating a 3D model, to acquire two-dimensional texture coordinates for texture-mapping the partial image indicated by the partial image information on the 3D model indicated by the 3D model information on a basis of the partial image information and the 3D model information, to acquire rendering condition information indicating a rendering condition that is a condition for rendering a 3D model with texture obtained by texture-mapping the partial image indicated by the partial image information on the 3D model indicated by the 3D model information on a basis of the two-dimensional texture coordinates, to acquire two-dimensional image information indicating a two-dimensional image by rendering the 3D model with texture on a basis of the rendering condition information, and to output the two-dimensional image information.

### Advantageous Effects of Invention

According to the present disclosure, even for an object having a complicated shape or pattern, it is possible to shorten the training time required for generating a trained model capable of accurately inferring the shape, center position, type, or the like of the object as compared with the related art.

### BRIEF DESCRIPTION OF DRAWINGS

FIG. 1 is a block diagram illustrating an example of a configuration of a main part of an object inference system in which a training data generation device according to a first embodiment is used.

FIG. 2 is a block diagram illustrating an example of a configuration of a main part of the training data generation device according to the first embodiment.

FIG. 3 is an explanatory diagram illustrating an example of a 3D model indicated by 3D model information acquired by a 3D model acquiring unit 110 included in the training data generation device according to the first embodiment.

FIG. 4A is an explanatory diagram illustrating an example of a photographed image indicated by photographed image information acquired by a photographed image acquiring unit included in the training data generation device according to the first embodiment. FIG. 4B is an explanatory diagram illustrating an example of a partial image extracted from the photographed image illustrated in FIG. 4A by the background difference method by a partial image acquiring unit included in the training data generation device according to the first embodiment.

FIG. 5A is an explanatory diagram illustrating an example of a UV development diagram in which a texture coordinate acquiring unit included in the training data generation device according to the first embodiment UV-develops the 3D model illustrated in FIG. 3. FIG. 5B is an explanatory diagram illustrating an example of the UV development diagram after the texture coordinate acquiring unit included in the training data generation device according to the first embodiment performs rotation and reduction on UV coordinates in the UV development diagram illustrated in FIG. 5A.

FIG. 6 is an explanatory diagram illustrating an example of a 3D model with texture according to the first embodiment.

FIGS. 7A and 7B are diagrams illustrating an example of a hardware configuration of the main part of the training data generation device according to the first embodiment.

FIG. 8 is a flowchart illustrating an example of processing of the training data generation device according to the first embodiment.

### DESCRIPTION OF EMBODIMENTS

Hereinafter, an embodiment of the present disclosure will be described in detail with reference to the drawings.

### First Embodiment

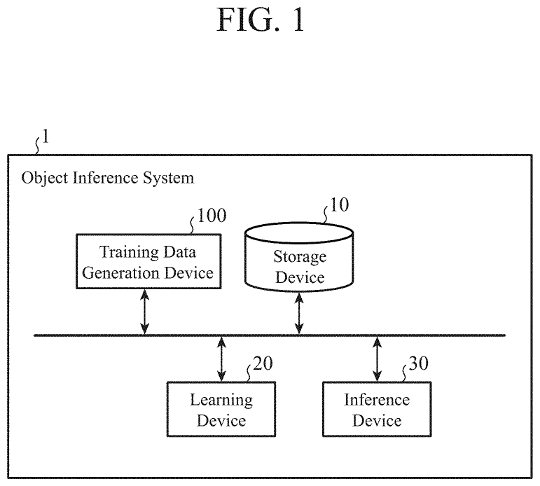

A training data generation device 100 according to a first embodiment will be described with reference to FIGS. 1 to 8.

FIG. 1 is a block diagram illustrating an example of a configuration of a main part of an object inference system 1 in which a training data generation device 100 according to a first embodiment is used.

The object inference system 1 includes a training data generation device 100, a storage device 10, a learning device 20, and an inference device 30.

The storage device 10 stores electronic information having a storage medium such as a solid state drive (SSD) or a hard disk drive (HDD). The storage device 10 is connected to the training data generation device 100, the learning device 20, the inference device 30, or the like via a wired communication means or a wireless communication means.

The training data generation device 100 generates training data used when machine learning for inferring a shape, a center position, a type, or the like of an object is performed, and outputs the generated training data to the learning device 20 or the storage device 10. Details of the training data generation device 100 will be described later.

The learning device 20 acquires training data and performs machine learning for inferring a shape, a center position, a type, or the like of an object using the acquired training data. Specifically, the learning device 20 acquires the training data output from the training data generation device 100 from the training data generation device 100 or the storage device 10 to perform the machine learning.

The learning device 20 outputs trained model information indicating a trained model corresponding to a learning result by the machine learning to the inference device 30 or the storage device 10. The trained model indicated by the trained model information output by the learning device 20 is, for example, a neural network including an input layer, an intermediate layer, an output layer, and the like.

The learning device 20 includes, for example, a general-purpose computer such as a personal computer.

The inference device 30 acquires photographed image information indicating a photographed image obtained by photographing an object of an inference target from the storage device 10 or an imaging device (not illustrated in FIG. 1). In addition, the inference device 30 acquires the trained model information output by the learning device 20 from the learning device 20 or the storage device 10. The inference device 30 inputs the acquired photographed image information as an explanatory variable to the trained model indicated by the acquired trained model information, thereby causing the trained model to infer the shape, center position, type, or the like of the object appearing in the photographed image indicated by the photographed image information. The inference device 30 outputs inference result information indicating a result of the inference by the trained model to the storage device 10 or an output device (not illustrated in FIG. 1). Note that the output device is, for example, a display output device such as a display. The output device is not limited to the display output device, and may be a lighting device such as a lamp, an audio output device such as a speaker, or the like. The output device acquires the inference result information output by the inference device 30, and outputs the acquired inference result information in a state in which the user can recognize the inference result information by light, voice, or the like.

Each of the inference device 30 and the learning device 20 is configured by, for example, a general-purpose computer such as a personal computer.

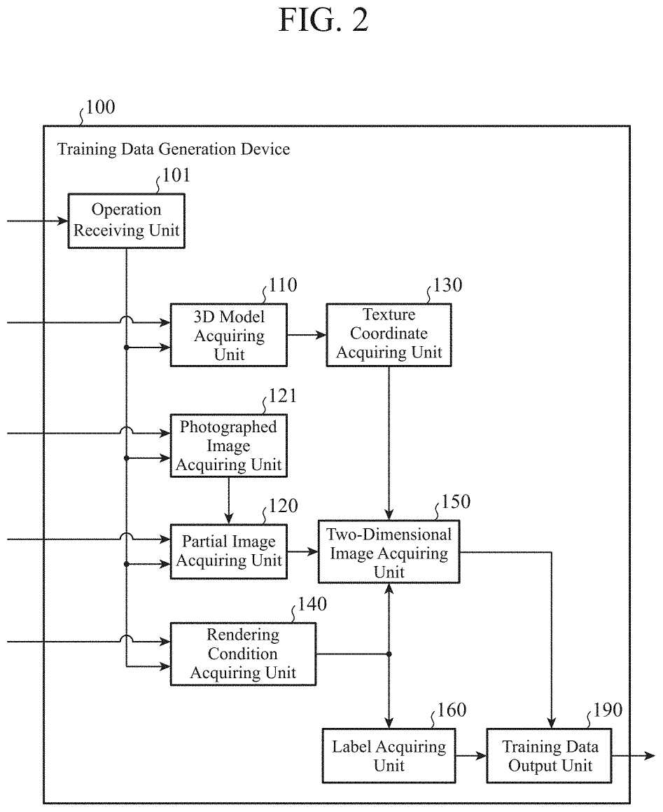

A configuration of a main part of the training data generation device 100 according to the first embodiment will be described with reference to FIG. 2.

FIG. 2 is a block diagram illustrating an example of the configuration of the main part of the training data generation device 100 according to the first embodiment.

The training data generation device 100 includes a 3D model acquiring unit 110, a partial image acquiring unit 120, a texture coordinate acquiring unit 130, a rendering condition acquiring unit 140, a two-dimensional image acquiring unit 150, and a training data output unit 190.

The training data generation device 100 may include an operation receiving unit 101, a photographed image acquiring unit 121, and a label acquiring unit 160 in addition to the 3D model acquiring unit 110, the partial image acquiring unit 120, the texture coordinate acquiring unit 130, the rendering condition acquiring unit 140, the two-dimensional image acquiring unit 150, and the training data output unit 190.

As illustrated in FIG. 2, the training data generation device 100 according to the first embodiment will be described as including the operation receiving unit 101, the 3D model acquiring unit 110, the partial image acquiring unit 120, the photographed image acquiring unit 121, the texture coordinate acquiring unit 130, the rendering condition acquiring unit 140, the two-dimensional image acquiring unit 150, the label acquiring unit 160, and the training data output unit 190.

The operation receiving unit 101 receives an operation signal output from an operation input device (not illustrated in FIG. 2) such as a keyboard or a pointing device, and converts the operation signal into operation information corresponding to the operation signal. Specifically, the operation receiving unit 101 receives an operation signal output from the operation input device when the a user operates the operation input device, and converts the operation signal into operation information corresponding to the operation signal.

The operation receiving unit 101 outputs the converted operation information to the 3D model acquiring unit 110, the partial image acquiring unit 120, the photographed image acquiring unit 121, the rendering condition acquiring unit 140, and the like.

The 3D model acquiring unit 110 acquires 3D model information indicating a three-dimensional (Hereinafter referred to as “3D”.) model. For example, the 3D model acquiring unit 110 acquires the 3D model information by reading out the 3D model information from the storage device 10. The 3D model acquiring unit 110 may hold 3D model information in advance. Furthermore, for example, the 3D model acquiring unit 110 may acquire the 3D model information on the basis of the operation information output by the operation receiving unit 101. More specifically, for example, a user designates the 3D model information stored in the storage device 10 by operating the operation input device. The operation receiving unit 101 receives an operation signal indicating the designated 3D model information, converts the operation signal into operation information corresponding to the operation signal, and outputs the operation information after conversion to the 3D model acquiring unit 110. The 3D model acquiring unit 110 reads out the 3D model information designated by the user from the storage device 10 by acquiring the operation information from the operation receiving unit 101, thereby acquiring the 3D model information desired by the user.

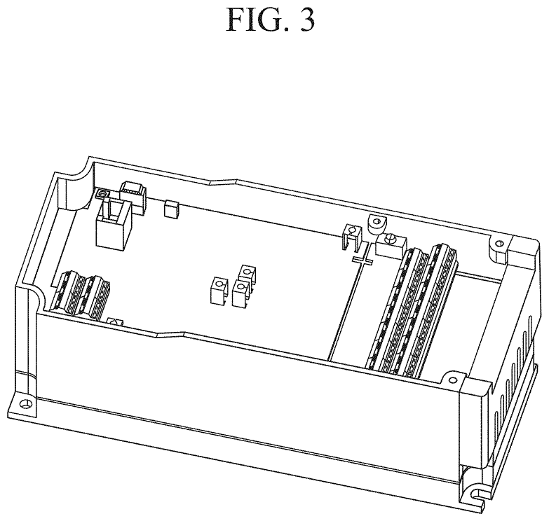

FIG. 3 is an explanatory diagram illustrating an example of a 3D model indicated by 3D model information acquired by the 3D model acquiring unit 110 included in the training data generation device 100 according to the first embodiment.

Specifically, FIG. 3 is obtained by visualizing the 3D model indicated by the 3D model information acquired by the 3D model acquiring unit 110 as a two-dimensional image by computer graphics (Hereinafter, referred to as “CG”.).

The partial image acquiring unit 120 acquires partial image information indicating a partial image that is an image area in which an object to be inferred appears in the photographed image.

Specifically, for example, the partial image acquiring unit 120 acquires the partial image information by reading out the partial image information from the storage device 10 in which the partial image information is stored in advance.

More specifically, for example, the partial image acquiring unit 120 acquires partial image information specified by the user through the operation input device on the basis of the operation information acquired by the operation receiving unit 101.

The photographed image acquiring unit 121 acquires photographed image information indicating a photographed image in which an object to be inferred appears.

Specifically, for example, the photographed image acquiring unit 121 acquires the photographed image information by reading out the photographed image information from the storage device 10 in which the photographed image information is stored in advance.

More specifically, for example, the photographed image acquiring unit 121 acquires the photographed image information specified by the user through the operation input device on the basis of the operation information acquired by the operation receiving unit 101.

In a case where the training data generation device 100 includes the photographed image acquiring unit 121, the partial image acquiring unit 120 may acquire the partial image information indicating the partial image that is the image area in which the object appears in the photographed image by performing foreground extraction by a background difference method on the photographed image indicated by the photographed image information acquired by the photographed image acquiring unit 121 and extracting a rectangular area including an extracted foreground area from the photographed image. The method of performing foreground extraction from an image by the background difference method is a well-known technique, and thus the description thereof will be omitted. In addition, the partial image acquiring unit 120 extracts a rectangular area including the foreground area from the photographed image by a single shot multibox detector (SSD) or the like. The method of extracting a rectangular area including a foreground area from an image such as an SSD is a well-known technique, and thus description thereof is omitted.

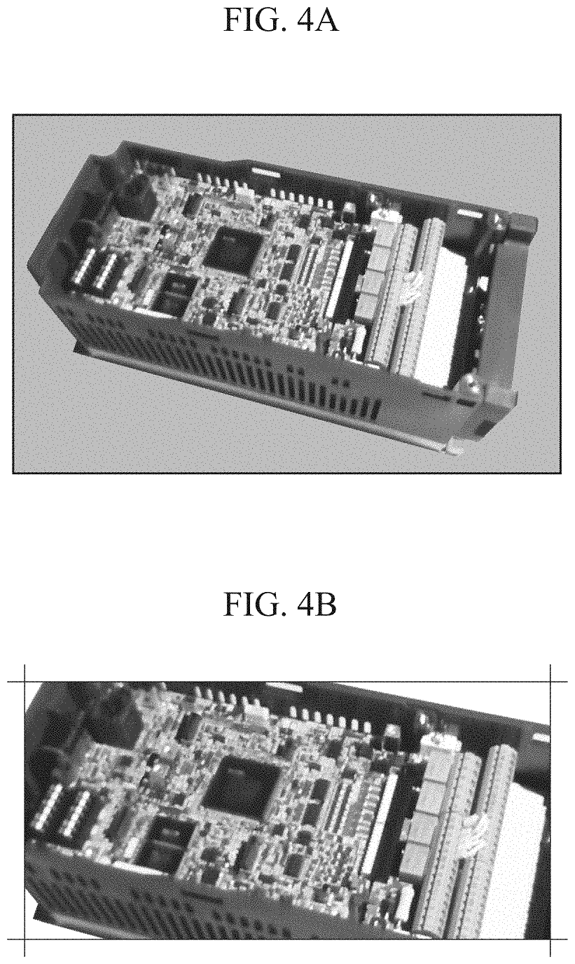

FIG. 4 is an explanatory diagram illustrating an example of a partial image extracted by the partial image acquiring unit 120 included in the training data generation device 100 according to the first embodiment, from a photographed image indicated by photographed image information acquired by the photographed image acquiring unit 121 by the background difference method.

Specifically, FIG. 4A is an explanatory diagram illustrating an example of a photographed image indicated by photographed image information acquired by the photographed image acquiring unit 121 included in the training data generation device 100 according to the first embodiment. In addition, FIG. 4B is an explanatory diagram illustrating an example of a partial image extracted from the photographed image illustrated in FIG. 4A by the partial image acquiring unit 120 included in the training data generation device 100 according to the first embodiment by the background difference method.

As illustrated in FIG. 4, the partial image acquiring unit 120 extracts a partial image illustrated in FIG. 4B as an example by extracting a rectangular area including a foreground area, which is an image area in which an object appears, from the photographed image illustrated in FIG. 4A as an example by the background difference method.

As described above, the partial image acquiring unit 120 is configured to acquire the partial image information indicating the partial image by extracting the partial image from the photographed image indicated by the photographed image information acquired by the photographed image acquiring unit 121, whereby the training data generation device 100 can automate the generation of the partial image information.

On the basis of the partial image information acquired by the partial image acquiring unit 120 and the 3D model information acquired by the 3D model acquiring unit 110, the texture coordinate acquiring unit 130 acquires two-dimensional texture coordinates for texture-mapping the partial image indicated by the partial image information on the 3D model indicated by the 3D model information.

Specifically, for example, the texture coordinate acquiring unit 130 UV-develops the 3D model indicated by the 3D model information, and acquires UV coordinates that are two-dimensional texture coordinates for texture-mapping the partial image indicated by the partial image information on the UV-developed 3D model.

A method for acquiring UV coordinates for texture-mapping an image on a UV-developed 3D model is a well-known technique, and thus description thereof is omitted.

The texture coordinate acquiring unit 130 may coordinate-transform the UV coordinates by performing at least one of rotation, translation, and enlargement or reduction on the acquired UV coordinates, and acquire transformed UV coordinates, which are the UV coordinates after transformation, as two-dimensional texture coordinates for texture-mapping the partial image on the 3D model.

For example, the UV coordinates can be coordinate-transformed into transformed UV coordinates using the following formula (1).

$$( \begin{matrix}{U}^{′} \\ {V}^{′}\end{matrix} ) = α ( \begin{matrix}cos θ & - sin θ \\ sin θ & cos θ\end{matrix} ) ( \begin{matrix}U - {offset}_{u} \\ V - {offset}_{v}\end{matrix} ) \qquad Formula ( 1 )$$

Here, (U, V) represents a UV coordinate, (U′, V′) represents a transformed UV coordinate, offsetᵤ and offsets represent movement amounts of translating the UV coordinate, θ represents an angle for rotating the UV coordinate, and a represents an enlargement (reduction) ratio for enlarging or reducing the UV coordinate.

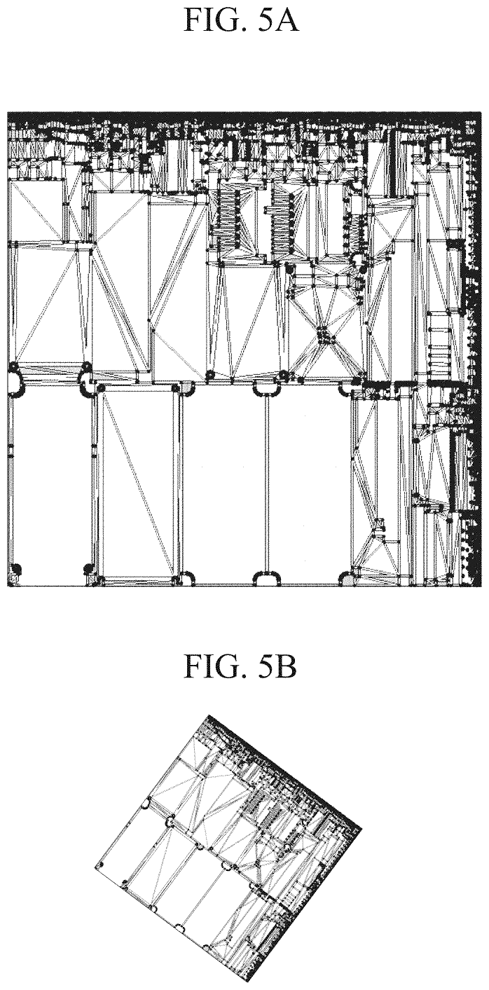

FIG. 5 is an explanatory diagram illustrating an example of a UV development diagram in which the texture coordinate acquiring unit 130 included in the training data generation device 100 according to the first embodiment UV-develops the 3D model illustrated in FIG. 3.

Specifically, FIG. 5A is an explanatory diagram illustrating an example of a UV development diagram in which the texture coordinate acquiring unit 130 included in the training data generation device 100 according to the first embodiment UV-develops the 3D model illustrated in FIG. 3. In addition, FIG. 5B is an explanatory diagram illustrating an example of the UV development diagram after the texture coordinate acquiring unit 130 included in the training data generation device 100 according to the first embodiment rotates and reduces the UV coordinates in the UV development diagram illustrated in FIG. 5A.

On the basis of the two-dimensional texture coordinates acquired by the texture coordinate acquiring unit 130, the rendering condition acquiring unit 140 acquires rendering condition information indicating a rendering condition that is a condition for rendering a 3D model with texture obtained by texture-mapping a partial image indicated by the partial image information on a 3D model indicated by the 3D model information.

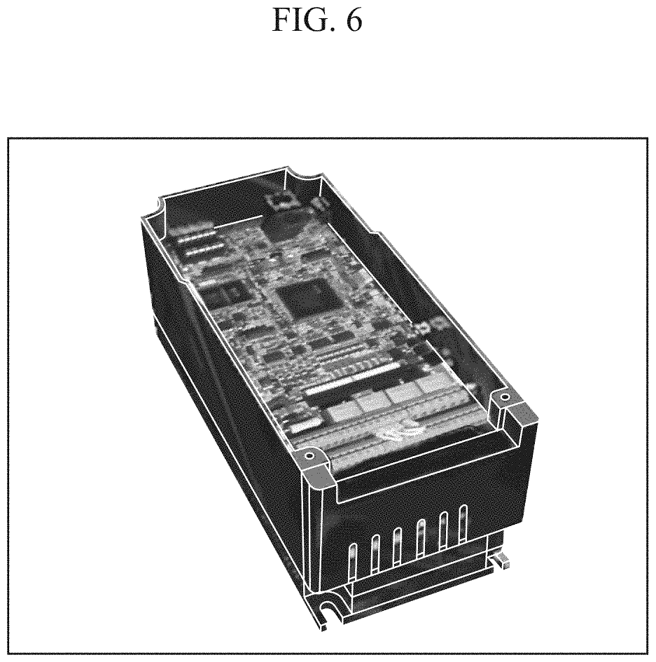

FIG. 6 is an explanatory diagram illustrating an example of a 3D model with texture according to the first embodiment.

Specifically, the 3D model with texture illustrated in FIG. 6 is obtained by texture-mapping the partial image illustrated in FIG. 4B as an example on the 3D model illustrated in FIG. 3 as an example on the basis of the UV development diagram illustrated in FIG. 5B as an example of the UV development diagram of the 3D model illustrated in FIG. 3 as an example.

For example, the rendering condition acquiring unit 140 acquires the rendering condition information by reading out the rendering condition information from the storage device 10 in which the rendering condition information is stored in advance.

Specifically, for example, the rendering condition information acquired by the rendering condition acquiring unit 140 indicates a condition when the 3D model with texture in a CG space is photographed with a virtual camera.

More specifically, for example, the rendering condition acquiring unit 140 acquires, as the rendering condition information, information indicating the position or attitude in a CG space of the 3D model indicated by the 3D model information acquired by the 3D model acquiring unit 110, the size of the 3D model including the bounding box in the CG space, the position or attitude of the virtual camera in the CG space, the position of the light source in the CG space, the color of the light emitted by the light source, or the like.

Note that the number of pieces of rendering condition information acquired by the rendering condition acquiring unit 140 is not limited to one, and the rendering condition acquiring unit 140 acquires a plurality of pieces of rendering condition information having different rendering conditions.

Furthermore, the method by which the rendering condition acquiring unit 140 acquires the rendering condition information is not limited to the method by which the rendering condition acquiring unit 140 acquires the rendering condition information by reading out the rendering condition information from the storage device 10.

For example, the rendering condition acquiring unit 140 acquires a rendering condition by reading out, from the storage device 10, information indicating a formula capable of determining the rendering condition such as the position or attitude in the CG space of the 3D model indicated by the 3D model information acquired by the 3D model acquiring unit 110, the size of the 3D model including the bounding box in the CG space, the position or attitude of the virtual camera in the CG space, or the position of the light source in the CG space or the color of the light emitted by the light source. The rendering condition acquiring unit 140 may acquire the rendering condition information by determining the rendering condition by substituting predetermined values into parameters included in the formula indicated by the information.

Here, the number of values substituted for the parameter by the rendering condition acquiring unit 140 is not limited to one, and a plurality of mutually different values may be substituted for the parameter, and the rendering condition acquiring unit 140 may determine the rendering condition by sequentially substituting a plurality of mutually different values for the parameter as a predetermined value.

On the basis of the rendering condition information acquired by the rendering condition acquiring unit 140, the two-dimensional image acquiring unit 150 acquires two-dimensional image information indicating a two-dimensional image by rendering the 3D model with texture.

Specifically, every time the rendering condition acquiring unit 140 acquires each of a plurality of pieces of mutually different rendering condition information, the two-dimensional image acquiring unit 150 acquires two-dimensional image information indicating a two-dimensional image by rendering the 3D model with texture on the basis of the rendering condition information acquired by the rendering condition acquiring unit 140.

The training data output unit 190 outputs the two-dimensional image information acquired by the two-dimensional image acquiring unit 150.

Specifically, the training data output unit 190 outputs the two-dimensional image information acquired by the two-dimensional image acquiring unit 150 every time the rendering condition acquiring unit 140 acquires each of a plurality of pieces of mutually different rendering condition information.

For example, the training data output unit 190 outputs the two-dimensional image information to the storage device 10 or the learning device 20.

The learning device 20 acquires the two-dimensional image information output by the training data output unit 190 as training data, performs machine learning using the acquired training data, and generates a trained model for inferring the shape, center position, type, or the like of the object.

With the above-described configuration, the training data generation device 100 can output a plurality of pieces of two-dimensional image information based on one piece of partial image information on the basis of partial image information indicating a partial image that is an image area in which an object appears in a photographed image obtained by photographing an object.

Since the learning device 20 performs machine learning by using the two-dimensional image information output by the training data generation device 100 as training data, the two-dimensional image indicated by the two-dimensional image information includes a partial image, and therefore, even in a case where the shape or pattern of the object to be inferred is complicated, the training time required for generating the trained model capable of accurately inferring the shape, center position, type, or the like of the object is shorter than that in the related art.

That is, even if an object has a complicated shape or pattern, the training data generation device 100 can shorten the training time required for generating the trained model capable of accurately inferring the shape, center position, type, or the like of the object as compared with the related art.

Note that, in addition to acquiring the two-dimensional image information, the two-dimensional image acquiring unit 150 may acquire accompanying image information indicating a segment image, a depth image, or the like corresponding to the two-dimensional image indicated by the two-dimensional image information.

The method of acquiring the segment image or the depth image by rendering the 3D model with textured is a well-known technique, and thus the description thereof will be omitted.

The training data generation device 100 may include the label acquiring unit 160.

The label acquiring unit 160 acquires label information indicating a label related to the two-dimensional image information acquired by the two-dimensional image acquiring unit 150.

In a case where the training data generation device 100 includes the label acquiring unit 160, the training data output unit 190 outputs the label information acquired by the label acquiring unit 160 in association with the two-dimensional image information, in addition to the two-dimensional image information indicated by the two-dimensional image acquiring unit 150.

Specifically, for example, every time the rendering condition acquiring unit 140 acquires each of a plurality of pieces of mutually different rendering condition information, the training data output unit 190 outputs the two-dimensional image information acquired by the two-dimensional image acquiring unit 150 and the label information acquired by the label acquiring unit 160 to the storage device 10 or the learning device 20 in association with each other.

The learning device 20 acquires the two-dimensional image information output by the training data output unit 190 and the label information associated with the two-dimensional image information as training data, performs machine learning using the acquired training data, and generates a trained model for inferring the shape, center position, type, or the like of the object.

For example, the label acquiring unit 160 acquires, as the label information, partial rendering information indicating at least a part of the rendering conditions indicated by the rendering condition information used when the two-dimensional image acquiring unit 150 acquires the two-dimensional image information. Since the rendering condition information has been described above, description thereof is omitted.

The label information acquired by the label acquiring unit 160 is not limited to partial rendering information.

For example, in a case where the two-dimensional image acquiring unit 150 acquires accompanying image information indicating a segment image, a depth image, or the like corresponding to the two-dimensional image indicated by the two-dimensional image information in addition to acquiring the two-dimensional image information, the label acquiring unit 160 may acquire the accompanying image information acquired by the two-dimensional image acquiring unit 150 as the label information.

With the above-described configuration, the training data generation device 100 can output a plurality of information sets in which two-dimensional image information based on one piece of partial image information and label information are associated with each other on the basis of partial image information indicating a partial image that is an image area in which an object appears in a photographed image obtained by photographing the object.

Since the learning device 20 performs machine learning by using the two-dimensional image information output by the training data generation device 100 as training data, the two-dimensional image indicated by the two-dimensional image information includes a partial image, and therefore, even in a case where the shape or pattern of the object to be inferred is complicated, the training time required for generating the trained model capable of accurately inferring the shape, center position, type, or the like of the object is shorter than that in the related art.

That is, even if an object has a complicated shape or pattern, the training data generation device 100 can shorten the training time required for generating the trained model capable of accurately inferring the shape, center position, type, or the like of the object as compared with the related art.

In addition, since the learning device 20 performs machine learning using the label information as the training data in addition to the two-dimensional image information output from the training data generation device 100, the training time required for generating the trained model is shortened as compared with the case of performing machine learning using only the two-dimensional image information as the training data.

That is, since the training data generation device 100 generates the information set in which the two-dimensional image information and the label information are associated with each other, even if an object has a complicated shape or pattern, the training time required for generating the trained model capable of accurately inferring the shape, center position, type, or the like of the object can be further shortened as compared with the related art.

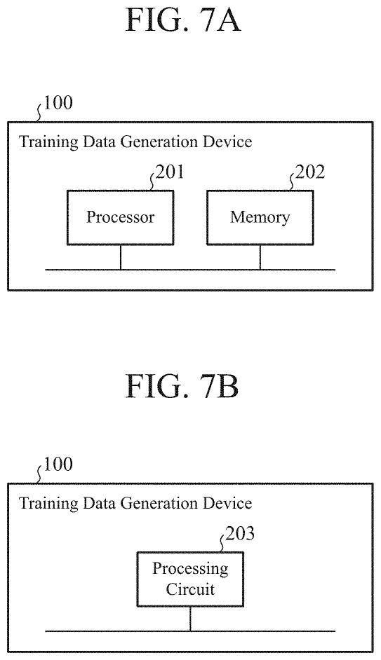

A hardware configuration of the main part of the training data generation device 100 according to the first embodiment will be described with reference to FIGS. 7A and 7B.

FIGS. 7A and 7B are diagrams illustrating an example of a hardware configuration of a main part of the training data generation device 100 according to the first embodiment.

As illustrated in FIG. 7A, the training data generation device 100 is configured by a computer, and the computer has a processor 201 and a memory 202. The memory 202 stores programs for causing the computer to function as the operation receiving unit 101, the 3D model acquiring unit 110, the partial image acquiring unit 120, the photographed image acquiring unit 121, the texture coordinate acquiring unit 130, the rendering condition acquiring unit 140, the two-dimensional image acquiring unit 150, the label acquiring unit 160, and the training data output unit 190. The processor 201 reads out and executes the programs stored in the memory 202, thereby implementing the operation receiving unit 101, the 3D model acquiring unit 110, the partial image acquiring unit 120, the photographed image acquiring unit 121, the texture coordinate acquiring unit 130, the rendering condition acquiring unit 140, the two-dimensional image acquiring unit 150, the label acquiring unit 160, and the training data output unit 190.

In addition, as illustrated in FIG. 7B, the training data generation device 100 may include a processing circuit 203. In this case, the functions of the operation receiving unit 101, the 3D model acquiring unit 110, the partial image acquiring unit 120, the photographed image acquiring unit 121, the texture coordinate acquiring unit 130, the rendering condition acquiring unit 140, the two-dimensional image acquiring unit 150, the label acquiring unit 160, and the training data output unit 190 may be implemented by the processing circuit 203.

Furthermore, the training data generation device 100 may include the processor 201, the memory 202, and the processing circuit 203 (not illustrated). In this case, some of the functions of the operation receiving unit 101, the 3D model acquiring unit 110, the partial image acquiring unit 120, the photographed image acquiring unit 121, the texture coordinate acquiring unit 130, the rendering condition acquiring unit 140, the two-dimensional image acquiring unit 150, the label acquiring unit 160, and the training data output unit 190 may be implemented by the processor 201 and the memory 202, and the remaining functions may be implemented by the processing circuit 203.

The processor 201 uses, for example, a central processing unit (CPU), a graphics processing unit (GPU), a microprocessor, a microcontroller, or a digital signal processor (DSP).

The memory 202 uses, for example, a semiconductor memory or a magnetic disk. More specifically, the memory 202 uses a random access memory (RAM), a read only memory (ROM), a flash memory, an erasable programmable read only memory (EPROM), an electrically erasable programmable read-only memory (EEPROM), a solid state drive (SSD), a hard disk drive (HDD), or the like.

The processing circuit 203 uses, for example, an application specific integrated circuit (ASIC), a programmable logic device (PLD), a field-programmable gate array (FPGA), a system-on-a-chip (SoC), or a system large-scale integration (LSI).

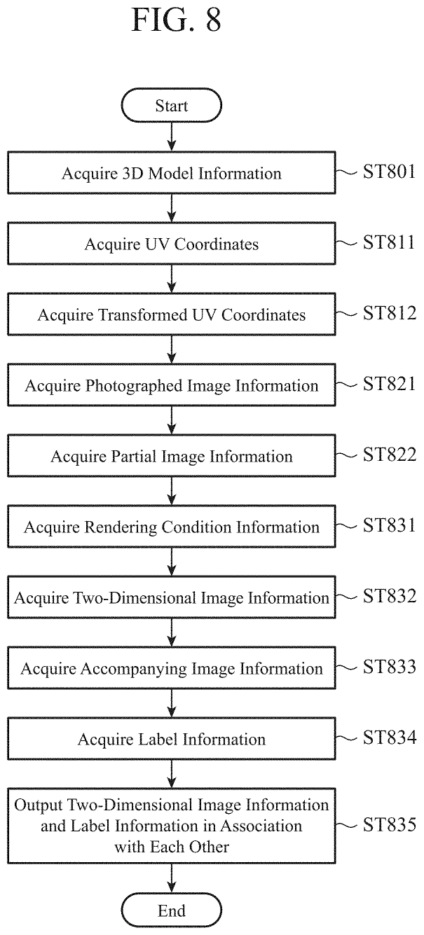

The operation of the training data generation device 100 according to the first embodiment will be described with reference to FIG. 8.

FIG. 8 is a flowchart illustrating an example of processing of the training data generation device 100 according to the first embodiment.

For example, the training data generation device 100 repeatedly executes the processing of the flowchart.

First, in step ST801, the 3D model acquiring unit 110 acquires 3D model information.

Next, in step ST811, the texture coordinate acquiring unit 130 acquires UV coordinates that are two-dimensional texture coordinates.

Next, in step ST812, the texture coordinate acquiring unit 130 acquires transformed UV coordinates.

Next, in step ST821, the photographed image acquiring unit 121 acquires photographed image information.

Next, in step ST822, the partial image acquiring unit 120 acquires partial image information.

Next, in step ST831, the rendering condition acquiring unit 140 acquires rendering condition information.

Next, in step ST832, the two-dimensional image acquiring unit 150 acquires two-dimensional image information.

Next, in step ST833, the two-dimensional image acquiring unit 150 acquires accompanying image information.

Next, in step ST834, the label acquiring unit 160 acquires label information.

Next, in step ST835, the training data output unit 190 outputs the two-dimensional image information and the label information in association with each other.

After executing the processing of step ST835, the training data generation device 100 ends the processing of the flowchart, and for example, returns to the processing of step ST801 and repeatedly executes the processing of the flowchart.

In a case where the two-dimensional image acquiring unit 150 repeatedly performs rendering by using the 3D model information acquired by the 3D model acquiring unit 110 in step ST801, the training data generation device 100 may end the processing of the flowchart after executing the processing of step ST835, return to the processing of step ST811 or step ST812, and repeatedly execute the processing of the flowchart.

Furthermore, in a case where the two-dimensional image acquiring unit 150 repeatedly performs rendering on the basis of the UV coordinates acquired by the texture coordinate acquiring unit 130 in step ST811, the training data generation device 100 may end the processing of the flowchart after executing the processing of step ST835, return to the processing of step ST812 or step ST821, and repeatedly execute the processing of the flowchart.

Furthermore, in a case where the two-dimensional image acquiring unit 150 repeatedly performs rendering on the basis of the transformed UV coordinates acquired by the texture coordinate acquiring unit 130 in step ST812, the training data generation device 100 may end the processing of the flowchart after executing the processing of step ST835, return to the processing of step ST821, and repeatedly execute the processing of the flowchart.

Furthermore, in a case where the partial image acquiring unit 120 repeatedly acquires the partial image information by using the photographed image information acquired by the photographed image acquiring unit 121 in step ST821, the training data generation device 100 may end the processing of the flowchart after executing the processing of step ST835, return to the processing of step ST822, and repeatedly execute the processing of the flowchart.

Furthermore, in a case where the rendering condition acquiring unit 140 repeatedly acquires the rendering condition information, and the two-dimensional image acquiring unit 150 repeatedly performs rendering for each piece of the rendering condition information repeatedly acquired by the rendering condition acquiring unit 140, the training data generation device 100 may end the processing of the flowchart after executing the processing of step ST835, return to the processing of step ST831, and repeatedly execute the processing of the flowchart.

Note that, in the flowchart, the processing in step ST812 can be omitted when the texture coordinate acquiring unit 130 does not have the function of acquiring transformed UV coordinates, the processing in step ST821 can be omitted when the partial image acquiring unit 120 does not have the function of extracting a partial image from a photographed image, and the processing in step ST833 can be omitted when the two-dimensional image acquiring unit 150 does not have the function of acquiring accompanying image information.

Furthermore, if the processing of step ST801 is executed before the processing of step ST811, the processing of step ST811 is executed before the processing of step ST812, and the processing of step ST821 is executed before the processing of step ST822, the order of the processing from step ST801 to step ST822 can be any order.

As described above, the training data generation device 100 includes: the 3D model acquiring unit 110 to acquire 3D model information indicating a 3D model; the partial image acquiring unit 120 to acquire partial image information indicating a partial image that is an image area in which an object appears in a photographed image; the texture coordinate acquiring unit 130 to acquire two-dimensional texture coordinates for texture-mapping the partial image indicated by the partial image information on the 3D model indicated by the 3D model information on the basis of the partial image information acquired by the partial image acquiring unit 120 and the 3D model information acquired by the 3D model acquiring unit 110; the rendering condition acquiring unit 140 to acquire rendering condition information indicating a rendering condition that is conditions for rendering the 3D model with texture obtained by texture-mapping the partial image indicated by the partial image information on the 3D model indicated by the 3D model information on the basis of the two-dimensional texture coordinates acquired by the texture coordinate acquiring unit 130; the two-dimensional image acquiring unit 150 to acquire two-dimensional image information indicating a two-dimensional image by rendering the 3D model with texture on the basis of the rendering condition information acquired by the rendering condition acquiring unit 140; and the training data output unit 190 to output the two-dimensional image information acquired by the two-dimensional image acquiring unit 150.

With the above configuration, even if an object has a complicated shape or pattern, the training data generation device 100 can shorten the training time required for generating the trained model capable of accurately inferring the shape, center position, type, or the like of the object as compared with the related art.

Furthermore, as described above, in addition to the above-described configuration, the training data generation device 100 includes the label acquiring unit 160 to acquire label information indicating a label related to two-dimensional image information acquired by the two-dimensional image acquiring unit 150, and the training data output unit 190 is configured to output the label information acquired by the label acquiring unit 160 in association with the two-dimensional image information, in addition to the two-dimensional image information acquired by the two-dimensional image acquiring unit 150.

With the above configuration, even if an object has a complicated shape or pattern, the training data generation device 100 can shorten the training time required for generating the trained model capable of accurately inferring the shape, center position, type, or the like of the object as compared with the related art.

Furthermore, as described above, in the above-described configuration, the training data generation device 100 is configured so that the two-dimensional image acquiring unit 150 acquires the accompanying image information indicating the segment image or the depth image corresponding to the two-dimensional image indicated by the two-dimensional image information in addition to acquiring the two-dimensional image information, and the label acquiring unit 160 acquires the accompanying image information acquired by the two-dimensional image acquiring unit 150 as the label information.

With the above configuration, even if an object has a complicated shape or pattern, the training data generation device 100 can shorten the training time required for generating the trained model capable of accurately inferring the shape, center position, type, or the like of the object as compared with the related art.

Furthermore, as described above, in the above-described configuration, the training data generation device 100 is configured so that the label acquiring unit 160 acquires, as the label information, partial rendering information indicating at least a part of rendering conditions among rendering conditions indicated by the rendering condition information which is used when the two-dimensional image acquiring unit 150 acquires the two-dimensional image information.

With the above configuration, even if an object has a complicated shape or pattern, the training data generation device 100 can shorten the training time required for generating the trained model capable of accurately inferring the shape, center position, type, or the like of the object as compared with the related art.

Furthermore, as described above, in addition to the above-described configuration, the training data generation device 100 includes the photographed image acquiring unit 121 to acquire the photographed image information indicating the photographed image in which the object appears, and the partial image acquiring unit 120 is configured to acquire the partial image information indicating the partial image that is the image area in which the object appears in the photographed image by performing foreground extraction by a background difference method on the photographed image indicated by the photographed image information acquired by the photographed image acquiring unit 121 and extracting a rectangular area including the extracted foreground area from the photographed image.

With the above configuration, even if an object has a complicated shape or pattern, the training data generation device 100 can eliminate the time and effort of generating the partial image information in advance while shortening the training time required for generating the trained model capable of accurately inferring the shape, center position, type, or the like of the object as compared with the related art.

Furthermore, as described above, in the above-described configuration, the training data generation device 100 is configured so that the texture coordinate acquiring unit 130 UV-develops the 3D model indicated by the 3D model information and acquires UV coordinates that are two-dimensional texture coordinates for texture-mapping the partial image indicated by the partial image information on the UV-developed 3D model.

With the above configuration, even if an object has a complicated shape or pattern, the training data generation device 100 can shorten the training time required for generating the trained model capable of accurately inferring the shape, center position, type, or the like of the object as compared with the related art.

Furthermore, as described above, in the above-described configuration, the training data generation device 100 is configured so that the texture coordinate acquiring unit 130 performs coordinate-transformation of the UV coordinates by performing at least one of rotation, translation, and enlargement or reduction on the acquired UV coordinates, and acquires transformed UV coordinates, which are the UV coordinates after the coordinate-transformation, as two-dimensional texture coordinates for texture-mapping the partial image onto the 3D model.

With the above configuration, even if an object has a complicated shape or pattern, the training data generation device 100 can shorten the training time required for generating the trained model capable of accurately inferring the shape, center position, type, or the like of the object as compared with the related art.

Furthermore, as described above, in the above-described configuration, the training data generation device 100 is configured so that the rendering condition acquiring unit 140 acquires, as the rendering condition information, information indicating at least one of the position and attitude of the 3D model in the CG space and the size of the 3D model including the bounding box in the CG space which are indicated by the 3D model information acquired by the 3D model acquiring unit 110, the position and attitude of the virtual camera in the CG space, the position of the light source in the CG space, and the color of the light emitted by the light source, which are conditions when the 3D model with texture in the CG space is photographed with the virtual camera.

With the above configuration, even if an object has a complicated shape or pattern, the training data generation device 100 can shorten the training time required for generating the trained model capable of accurately inferring the shape, center position, type, or the like of the object as compared with the related art.

### Modification of First Embodiment

The training data generation device 100 according to the first embodiment outputs two-dimensional image information or two-dimensional image information and label information associated with the two-dimensional image information in a case where there is a single object to be inferred.

For a case where there are a plurality of objects to be inferred, the training data generation device 100 may output two-dimensional image information or two-dimensional image information and label information associated with the two-dimensional image information.

Hereinafter, for a case where there are a plurality of objects to be inferred, a case where the training data generation device 100 outputs two-dimensional image information or two-dimensional image information and label information associated with the two-dimensional image information will be described.

Specifically, for example, the 3D model acquiring unit 110 acquires 3D model information corresponding to each of a plurality of objects to be inferred. That is, the 3D model acquiring unit 110 acquires 3D model information as many as the number of objects to be inferred.

Furthermore, the partial image acquiring unit 120 acquires, for example, partial image information corresponding to each of a plurality of objects to be inferred. That is, the partial image acquiring unit 120 acquires partial image information as many as the number of objects to be inferred.

For example, on the basis of the plurality of pieces of partial image information acquired by the partial image acquiring unit 120 and the plurality of pieces of 3D model information acquired by the 3D model acquiring unit 110, the texture coordinate acquiring unit 130 acquires, for each piece of 3D model information, two-dimensional texture coordinates for texture-mapping a partial image indicated by partial image information corresponding to 3D model information on a 3D model indicated by each of the plurality of pieces of 3D model information.

Specifically, for example, the texture coordinate acquiring unit 130 UV-develops the 3D model indicated by each of the plurality of pieces of 3D model information, and acquires, for each piece of 3D model information, UV coordinates that are two-dimensional texture coordinates for texture-mapping a partial image indicated by partial image information corresponding to the 3D model information on each of the plurality of UV-developed 3D models.

It is preferable that the texture coordinate acquiring unit 130 coordinate-transforms the UV coordinates acquired for each piece of 3D model information by performing at least one of rotation, translation, and enlargement or reduction on the UV coordinates, and acquires transformed UV coordinates, which are UV coordinates after transformation, as two-dimensional texture coordinates for texture-mapping a partial image on a 3D model.

As described above, the texture coordinate acquiring unit 130 coordinate-transforms the UV coordinates acquired for each piece of 3D model information by performing at least one of rotation, translation, and enlargement or reduction on the UV coordinates, so that the training data generation device 100 can variously arrange the 3D models with texture corresponding to each of the plurality of objects to be inferred in the CG space.

On the basis of the two-dimensional texture coordinates acquired for each piece of 3D model information by the texture coordinate acquiring unit 130, the rendering condition acquiring unit 140 acquires rendering condition information indicating a rendering condition that is a condition for rendering a plurality of 3D models with texture obtained by texture-mapping a partial image indicated by partial image information corresponding to the 3D model information on a 3D model indicated by each of a plurality of pieces of 3D model information together.

On the basis of the rendering condition information acquired by the rendering condition acquiring unit 140, the two-dimensional image acquiring unit 150 acquires two-dimensional image information indicating a two-dimensional image by rendering the 3D models with texture corresponding to each of the plurality of objects to be inferred together.

The training data output unit 190 outputs the two-dimensional image information acquired by the two-dimensional image acquiring unit 150.

With the above configuration, even in a case where there are a plurality of objects having a complicated shape or pattern, the training data generation device 100 can shorten the training time required for generating the trained model capable of accurately inferring the shape, center position, type, or the like of each of the plurality of objects as compared with the related art.

### Another Modification of First Embodiment

The training data generation device 100 according to the first embodiment acquires 3D model information corresponding to an object to be inferred, and renders a 3D model with texture obtained by texture-mapping a partial image that is an image area where the object appears on a 3D model indicated by the 3D model information, thereby outputting two-dimensional image information or two-dimensional image information and label information associated with the two-dimensional image information.

The training data generation device 100 may acquire background model information indicating a background model, which is a 3D model corresponding to the background of the object, in addition to the 3D model information corresponding to the object to be inferred, and output the two-dimensional image information or the two-dimensional image information and the label information associated with the two-dimensional image information by rendering the 3D model with background texture obtained by texture-mapping the background image on the background model and the 3D model with texture obtained by texture-mapping the partial image in which the object to be inferred appears on the 3D model together.

Hereinafter, a case where the training data generation device 100 outputs two-dimensional image information or two-dimensional image information and label information associated with the two-dimensional image information by rendering a 3D model with background texture obtained by texture-mapping a background image on a background model and a 3D model with texture obtained by texture-mapping a partial image in which an object to be inferred appears on a 3D model together will be described.

Specifically, for example, the 3D model acquiring unit 110 acquires 3D model information (Hereinafter referred to as “object model information”.) indicating a 3D model (Hereinafter, referred to as an “object model”.) corresponding to an object to be inferred and background model information indicating a background model that is a 3D model corresponding to a background of the object.

Furthermore, the partial image acquiring unit 120 acquires, for example, partial image information (Hereinafter, referred to as “object partial image information”.) indicating a partial image (Hereinafter, referred to as an “object partial image”.) in which an object to be inferred appears, and partial image information (Hereinafter, referred to as “background image information”.) indicating a partial image (Hereinafter, referred to as a “background image”.) that is an image area in which no object appears in the photographed image.

For example, on the basis of the object partial image information acquired by the partial image acquiring unit 120 and the object model information acquired by the 3D model acquiring unit 110, the texture coordinate acquiring unit 130 acquires two-dimensional texture coordinates for texture-mapping the object partial image indicated by the object partial image information on the object model indicated by the object model information. Furthermore, for example, on the basis of the background image information acquired by the partial image acquiring unit 120 and the background model information acquired by the 3D model acquiring unit 110, the texture coordinate acquiring unit 130 acquires two-dimensional texture coordinates for texture-mapping the background image indicated by the background image information on the background model indicated by the background model information.

Specifically, for example, the texture coordinate acquiring unit 130 UV-develops the object model indicated by the object model information, and acquires UV coordinates that are two-dimensional texture coordinates for texture-mapping the object partial image indicated by the object partial image information on the UV-developed object model. In addition, the texture coordinate acquiring unit 130 UV-develops the background model indicated by the background model information, and acquires UV coordinates that are two-dimensional texture coordinates for texture-mapping the background image indicated by the background image information on the UV-developed background model.

It is preferable that the texture coordinate acquiring unit 130 coordinate-transforms UV coordinates acquired by UV-developing the object model by performing at least one of rotation, translation, and enlargement or reduction on the UV coordinates, and acquires the transformed UV coordinates, which are the UV coordinates after transformation, as two-dimensional texture coordinates for texture-mapping the object partial image on the object model. In addition, it is preferable that the texture coordinate acquiring unit 130 coordinate-transforms UV coordinates acquired by UV-developing the background model by performing at least one of rotation, translation, and enlargement or reduction on the UV coordinates, and acquires transformed UV coordinates, which are the UV coordinates after transformation, as two-dimensional texture coordinates for texture-mapping the background image on the background model.

As described above, the texture coordinate acquiring unit 130 coordinate-transforms UV coordinates by performing at least one of rotation, translation, and enlargement or reduction on the UV coordinates acquired by UV-developing each of the object model and the background model, so that the training data generation device 100 can variously arrange the 3D model with texture corresponding to the object to be inferred and the 3D model with background texture that is the 3D model with texture corresponding to the background of the object in the CG space.

The rendering condition acquiring unit 140 acquires rendering condition information indicating a rendering condition that is a condition for rendering the 3D model with texture corresponding to the object to be inferred and the 3D model with background texture corresponding to the background of the object together.

On the basis of the rendering condition information acquired by the rendering condition acquiring unit 140, the two-dimensional image acquiring unit 150 acquires two-dimensional image information indicating a two-dimensional image by rendering the 3D model with texture corresponding to the object to be inferred and the 3D model with background texture corresponding to the background of the object together.

The training data output unit 190 outputs the two-dimensional image information acquired by the two-dimensional image acquiring unit 150.

With the above configuration, even if an object has a complicated shape or pattern, the training data generation device 100 can shorten the training time required for generating the trained model capable of accurately inferring the shape, center position, type, or the like of the object as compared with the related art.

It should be noted that the present disclosure can freely combine the embodiments, modify any constituent element of each embodiment, or omit any constituent element in each embodiment within the scope of the disclosure.

### INDUSTRIAL APPLICABILITY

The training data generation device according to the present disclosure can be used in an object inference system, a learning system, an inference system, or the like.

### REFERENCE SIGNS LIST

1: object inference system, 10: storage device, 20: learning device, 30: inference device, 100: training data generation device, 101: operation receiving unit, 110: 3D model acquiring unit, 120: partial image acquiring unit, 121: photographed image acquiring unit, 130: texture coordinate acquiring unit, 140: rendering condition acquiring unit, 150: two-dimensional image acquiring unit, 160: label acquiring unit, 190: training data output unit, 201: processor, 202: memory, 203: processing circuit

1. A training data generation device comprising processing circuitry
to acquire 3D model information indicating a 3D model of an object,
to acquire partial image information indicating a partial image that is an image area in which the object appears in a photographed image,
to acquire two-dimensional texture coordinates for texture-mapping the partial image indicated by the partial image information on the 3D model indicated by the 3D model information on a basis of the partial image information and the 3D model information,
to acquire rendering condition information indicating a rendering condition that is a condition for rendering a 3D model with texture obtained by texture-mapping the partial image indicated by the partial image information on the 3D model indicated by the 3D model information on a basis of the two-dimensional texture coordinates,
to acquire two-dimensional image information indicating a two-dimensional image by rendering the 3D model with texture on a basis of the rendering condition information, and
to output the two-dimensional image information.

2. The training data generation device according to claim 1, wherein the processing circuitry further performs to acquire label information indicating a label related to the two-dimensional image information, to output the label information in association with the two-dimensional image information, in addition to the two-dimensional image information.

3. The training data generation device according to claim 2, wherein the processing circuitry acquires accompanying image information indicating a segment image or a depth image corresponding to the two-dimensional image indicated by the two-dimensional image information in addition to acquiring the two-dimensional image information, and
the processing circuitry acquires the accompanying image information as the label information.

4. The training data generation device according to claim 2, wherein the processing circuitry acquires, as the label information, partial rendering information indicating at least a part of rendering conditions among the rendering conditions indicated by the rendering condition information which is used when the processing circuitry acquires the two-dimensional image information.

5. The training data generation device according to claim 1, wherein the processing circuitry further performs to acquire photographed image information indicating the photographed image in which the object appears, wherein
the processing circuitry acquires the partial image information indicating the partial image that is the image area in which the object appears in the photographed image by performing foreground extraction by a background difference method on the photographed image indicated by the photographed image information and extracting a rectangular area including an extracted foreground area from the photographed image.

6. The training data generation device according to claim 1, wherein the processing circuitry UV-develops the 3D model indicated by the 3D model information, and acquires UV coordinates that are the two-dimensional texture coordinates for texture-mapping the partial image indicated by the partial image information on the UV-developed 3D model.

7. The training data generation device according to claim 6, wherein the processing circuitry performs coordinate-transformation of the UV coordinates by performing at least one of rotation, translation, and enlargement or reduction on the acquired UV coordinates, and acquires transformed UV coordinates, which are the UV coordinates after the coordinate-transformation, as the two-dimensional texture coordinates for texture-mapping the partial image onto the 3D model.

8. The training data generation device according to claim 1, wherein the processing circuitry acquires, as the rendering condition information, information indicating at least one of a position and an attitude of the 3D model in a CG space and a size of the 3D model including a bounding box in the CG space which are indicated by the 3D model information, a position and an attitude of a virtual camera in the CG space, and a position of a light source in the CG space and a color of light emitted by the light source, which are conditions when the 3D model with texture in the CG space is photographed with the virtual camera.

9. A training data generation method, comprising:
a 3D model acquiring step of acquiring 3D model information indicating a 3D model of an object;
a partial image acquiring step of acquiring partial image information indicating a partial image that is an image area in which the object appears in a photographed image;
a texture coordinate acquiring step of acquiring two-dimensional texture coordinates for texture-mapping the partial image indicated by the partial image information on the 3D model indicated by the 3D model information on a basis of the partial image information acquired by the partial image acquiring step and the 3D model information acquired by the 3D model acquiring step;
a rendering condition acquiring step of acquiring rendering condition information indicating a rendering condition that is a condition for rendering a 3D model with texture obtained by texture-mapping the partial image indicated by the partial image information on the 3D model indicated by the 3D model information on a basis of the two-dimensional texture coordinates acquired by the texture coordinate acquiring step;
a two-dimensional image acquiring step of acquiring two-dimensional image information indicating a two-dimensional image by rendering the 3D model with texture on a basis of the rendering condition information acquired by the rendering condition acquiring step; and
a training data output step of outputting the two-dimensional image information acquired by the two-dimensional image acquiring step.
